(19) United States
(12) Patent Application Publication
(10) Pub. No.: US 2024/0095378 A1
(43) Pub. Date: Mar. 21, 2024

(54) METHOD FOR ENCRYPTING SECURITY-RELEVANT DATA IN A VEHICLE

(71) Applicant: Continental Automotive Technologies GmbH, Hannover (DE)

(72) Inventor: Helge Zinner, Hannover (DE)

(21) Appl. No.: 18/273,135

(22) PCT Filed: Jan. 19, 2022
(86) PCT No.: PCT/DE2022/200006

§ 371 Date: Jul. 19, 2023

(30) Foreign Application Priority Data
Jan. 21, 2021 (DE) 10 2021 000 557.0

(51) Int. Cl. G06F 21/60

(52) U.S. Cl. CPC G06F 21/602

(57) ABSTRACT

A method for encrypting security-relevant data in the vehicle, wherein, if the communication subscriber is located outside of the ECU, a request is made to set up a secure connection from one communication subscriber to the other communication subscriber, wherein the security mechanism for setting up a secure connection is effected depending on the distance ascertained.

### CROSS REFERENCE TO RELATED APPLICATIONS

This application is the U.S. National Phase Application of PCT International Application No. PCT/DE2022/200006, filed Jan. 19, 2022, which claims priority to German Patent Application No. 10 2021 000 557.0, filed Jan. 21, 2021, the contents of such applications being incorporated by reference herein.

### BACKGROUND OF THE INVENTION

On the basis of the Ethernet physical layer and the Internet protocol above it, techniques which have already been wide-spread for decades outside of the vehicle are finding their way into the on-board electrical system for the first time. In this case, there is also a potentially higher risk of attack that does not exist at present with the on-board electrical systems such as CAN and FlexRay, since the “normal hacker” simply does not have the know-how for this. Particularly with respect to the ever increasing use of the Ethernet and IP protocols, and also through the use of 5G, security mechanisms are becoming increasingly important because the car has already been identified as a new point of attack. This is exactly why there is a constant need for new and enhanced security mechanisms and functions that make the car more secure against attacks.

Ethernet and wireless technologies are only now finding their way into automobiles, and their open and standardized protocols make it possible, for the first time, to attack the car from the outside. There are increasing reports in the press about attacks on vehicles in which attackers have managed to gain access to the vehicle via radio and have thus also been able to access important vehicle functions.

In this case, the challenge of the firewalls (or of security in general) is to implement them with high performance in the control devices of the vehicle. The controllers, which will still be relatively computationally weak even in the future, and the increasing requirements of energy saving mean that known concepts from IT are not able to be adapted so easily. The quality of the security concept in the vehicle is therefore also always at odds with the available computing power. Some car manufacturers are currently already calling for separate controllers that implement the firewall functionality. Firstly for security reasons and secondly for performance reasons.

Continental, and also the whole industry, is working on new server-based architectures as is shown, for example, in FIG. 2 below.

The fundamental revolution of the new architectures is characterized by the centering of the software on fewer and fewer computing units. These so-called servers or central computers no longer only consist of just one μC or μP but contain several μC, μP, SOC and also Ethernet switches with a large number of ports—they represent a dedicated local network with individual software in each case (this also means that the respective software components do not (cannot) know that they are communicating with components located in the same housing, for example).

Zone architectures with central servers are known. Here, on the one hand, the server contains many powerful processors and, on the other hand, a lot of software or applications are executed on it. The communication effort within the control device is enormous (this represents a dedicated local network). The entire software of the vehicle will be executed here in the future and each controller has its own software stack which is provided by different suppliers.

Concepts in order to (dynamically) transfer functions and applications to other control devices/processors, i.e. also in order to optimize them, are known. This is referred to as live migration, reallocation or migration. The series application for the transfer of software to other ECUs/processors (within the automobile) is expected for OEMs as early as 2021.

By virtue of the new architectures (for example VW, Porsche, Audi), now for the first time there are possibilities for implementing software on different ECUs as well, since the hardware is becoming more generalized and the software less dependent on the platform. (Of course, this is not possible with all functions and ECUs). Therefore, what software will run on what control unit (server) is not always definite at the time when the system is designed. The shift in software is not limited here to ECU-to-ECU operations, however, but applies even more to controller-to-controller operations within the same ECU.

First of all, NFC (near field communication) is deemed secure per se because devices are only able to exchange in a spatially very small field. The maximum distance between two stations such as, for example, a cell phone or card with the terminal is usually only a few centimeters. In the case of greater distances, a data flow is no longer possible. As such, it is hardly conceivable that someone could intercept your data.

US 2019045475 A1, incorporated herein by reference, discloses approaches for managing the internal time synchronization. An Internet of Things (IoT) device is described, which is configured to determine a transport delay value as a function of a transmission path delay that corresponds to a first message that is sent from an I/O device of the IoT device to a central timer of the IoT device, and a reception path delay that corresponds to a second message that is sent from the central timer to the I/O device. The IoT device is configured such that, in reaction to receiving a radio message from the central timer following determination of the transport delay value, it updates a timestamp value of the received radio message as a function of the transport delay value.

### SUMMARY OF THE INVENTION

If IP data are exchanged between different subscribers by means of Ethernet, IP/MAC addresses are therefore used for addressing purposes. Firstly, a transmitter never knows exactly where this unit is located, and secondly, whether the receiver is even an attacker or not. The IP or MAC address does not provide any information about this. An IP address can additionally be easily changed and falsified—this can be easily manipulated.

This problem addresses very expensive extensions of the Ethernet such as, for example, MACsec, which allows an authentication. These modules are still not available at present, however, and are furthermore very much more expensive than the already expensive Ethernet modules. Furthermore, the manufacturers provide proprietary solutions for which we have to additionally pay for licence costs and which are not compatible with other semiconductor solutions.

There are currently still not enough security mechanisms to sufficiently safeguard Ethernet for the automotive field. The upcoming purchase of the company Argus CyberSecurity will also not be the miracle cure for security solutions because the current security solutions are 100% restricted to software and are implemented by firewalls. Firstly, these always consume a large amount of resources and secondly, the attacker is already always in the system.

As the problem was first clarified by Intel, errors can also arise deep in the hardware, which errors in principle cannot be recognized by a firewall. Furthermore, at present the firewalls represent the only security method/component in the vehicle. With respect to the automated and autonomous driving, on the subject of security, redundancy will also be necessary, which makes the on-board electrical system more secure against attacks. At present, there are still not any solutions for this in the on-board electrical system.

The increasing use of cameras automatically raises the question of data protection and protection of the private individual. For example, video surveillance naturally constitutes a significant interference in the personal rights of the employees as those affected. Individuals have the constitutionally protected right to determine their own image and the use thereof. As a result of video surveillance in the vehicle (interior, surroundings)—also for the purpose of theft prevention—there is always the latent risk of employees being monitored and these data being transmitted externally or else being stored in unencrypted form.

Forthcoming autonomously driving vehicles are equipped with at least 8 cameras and also data loggers. Encryption in order to protect the data of the outside world and also of the driver is a forthcoming issue—especially in view of the data loggers currently being developed, which are intended to record precisely these data.

The powerful ECUs internalize a plurality of controllers and also a plurality of switches in a “box”. This follows the trend for generally reducing the control devices in a vehicle. Security solutions have to be provided especially for these control devices, since in this case a very large ECU and therefore a very large number of functions can be erased in an attack, in comparison to a normal ECU at present.

Modern vehicle networks are configured statically, that is to say the data communication (transmitter, receiver and data relationship) is fixed at the latest when the vehicle is programmed at the end of the line. The forthcoming architectures and the desire for service-oriented communication contradict the current approach and require new concepts. For the next generations, it will not always be clear who the receiver of the data will be and which way the data will go. Each receiver may therefore have different requirements in terms of data transmission (for example, external ECU=cloud, unprotected ECU, etc.). In the future, said receiver will have to react dynamically to the requirements of the receiver and change the data transmission mechanisms, i.e. changed architecture and dynamic data transmission.

An aspect of the invention is to specify cheaper solutions for ensuring security in a vehicle, in particular for securing communication in the vehicle for automated driving by way of an ever greater number of connections.

An advantageous configuration of the method for encrypting security-relevant data in the vehicle is distinguished in that an address of the respective communication subscriber 210 in an Ethernet network is identified via the IP addresses, the propagation time to this communication partner 220 is measured, the distance to and/or the position in relation to this controller and/or application 230 is determined, wherein, if it is determined that the distance is below the threshold value 240, the application (μC, μP, SOC) is classified as trustworthy.

A further advantageous configuration of the method is distinguished in that, for verification purposes, safeguarding is effected by means of another protocol.

A particularly advantageous configuration of the method is distinguished in that, following measurement of the propagation time to this communication partner (220) and following determination of the distance to and/or the position in relation to this controller and/or application (230), a check is performed on the measurement of the propagation time in such a manner that, if a propagation time is shorter than the propagation time within the ECU, the communication subscriber is located on the same printed circuit board, if a propagation time is shorter than the propagation time within the vehicle, the communication subscriber is located within the vehicle, if a propagation time is shorter than the propagation time within the internal router, the communication subscriber is directly connected to the vehicle, if a propagation time is longer than those in points a), b) and c), the communication subscriber is located outside of the vehicle.

A further configuration of the method is distinguished in that, following analysis of the propagation time, a check is performed to determine whether the propagation time is longer than double the PHY latency, wherein, if a propagation time is longer than double the PHY latency, the communication subscriber is located outside of the ECU, and wherein, if a propagation time is shorter than double the PHY latency, the communication subscriber is not directly connected.

A further particularly advantageous configuration of the method is characterized in that, if the communication subscriber is located outside of the ECU, a request is made to set up a secure connection from one communication subscriber to the other communication subscriber, wherein the security mechanism for setting up a secure connection is effected depending on the distance ascertained.

An aspect of the invention advantageously increases the security in the vehicle on-board electrical system and safeguards driver assistance systems. The time synchronization is the elementary module of any Ethernet-based communication and also between bus systems (CAN/Ethernet) and in this case serves as the trigger. An aspect of the invention achieves a reduction and recognition of attacks and attack potentials, since hacker attacks on IP-based vehicle networks are to be expected more and more frequently. The security in the field of Ethernet is therefore increased.

An aspect of the invention proposes being oriented toward the fundamental concept of NFC, in which the physical distance between subscribers is sufficient for a trustworthy connection. Since, however, the control devices in the car are not able to physically approach one another, the notification of an aspect of the invention proposes a completely new proposal. Since we want to offer software in an ever simpler and more generalized manner and across platforms, something like this also cannot be encoded statically, but rather has to be learned in the service-oriented environment.

An aspect of the invention proposes a method that recognizes exactly where a communication partner is located in the vehicle (PCB, other ECU, connected to the vehicle or somewhere on the Internet). Using the address thereof and with the help of a presented measurement method, a calculation is performed to determine whether the partner is located in the immediate vicinity (i.e. on the same printed circuit board—PCB) or can be somewhere in the on-board electrical system, and therefore potentially be an attacker. An IP/Ethernet address can be falsified easily, but the signal propagation time only with great difficulty.

An aspect of the invention solves the above-described problem by measuring whether a subscriber is located within the dedicated ECU—i.e. on the printed circuit board—(i.e. another μC) or whether the subscriber is located, for example, on the Internet or somewhere in the on-board electrical system and is possibly a unit connected therebetween. It is more difficult per se to exchange a chip on a printed circuit board within an ECU; there are sufficient methods for this other than placing it somewhere in between in the on-board electrical system. Especially due to Ethernet and IP, it has become significantly simpler.

The effect provided by the method, namely protection against unauthorized attack, distortion of the communication, and against the exchange of devices, can also be achieved in other ways and with an even higher security level, for example by using hardware encryption (or authentication). The method allows protective mechanisms to be provided more cheaply and also reduces the system costs. The method can even be imported later via OTA and provides us with the possibility of selling security software.

In contrast, in vehicles, it is generally not economical to buy hardware equipment sufficient for seamlessly encrypted communication for all subscribers connected to the network. The method described requires significantly fewer hardware resources (can be put into action using existing implementations) and thus significantly increases the security level without this necessarily being linked to higher production costs for the network or devices connected thereto.

This method may be implemented in particular in the form of software that can be distributed as an update or upgrade for existing software or firmware of subscribers in the network and in this respect constitutes an independent product.

The quality of the execution of software-based applications (e.g. automated driving) can advantageously be increased by an aspect of the invention, in particular without additional financial outlay. The use of the newly introduced Ethernet protocol in automobiles necessitates mechanisms that make use of simple techniques and given properties of technologies in order to be able to do without expensive implementations and further additional hardware. The network system according to an aspect of the invention is improved in terms of costs and reliability. By means of software-based methods, Continental can thereby get the best out of its ECU or the network and offer customers more functionality.

Advantageously, the security of a vehicle network can be increased significantly and very simply by an aspect of the invention, in particular without additional financial outlay. Proprietary solutions can thereby be avoided. The use of the newly introduced Ethernet protocol in automobiles necessitates mechanisms that make use of simple techniques and given properties of technologies in order to be able to do without expensive implementations and further additional hardware. Earlier detection of attacks and abnormal behavior by means of early analysis of the communication paths allows gaps and errors to be identified before the vehicle is delivered. The network system according to an aspect of the invention is improved in terms of costs and reliability. The testability of the system is defined more clearly by an aspect of the invention and this allows test costs to be saved. In addition, an aspect of the invention affords transparent security functionality.

### Platform-Independent Software and Higher Quality

Nowadays, we sell applications that are tailored and adapted to an OEM or exactly one project. This notification of an aspect of the invention presents methods that allow our software to be designed somewhat more flexibly and make the best of the underlying system—without having to program it permanently into the software beforehand. At present we actually have to assume the worst case, which costs resources (money) and loses quality. An aspect of the invention permits software developers and software architects to provide software/applications that can be tailored to the requirements of the application more flexibly and precisely. Incorporating the mentioned methods into our software allows optimization to take place in each case for the customer (OEM) (or within our control device). This means that our software can be more independent of platform and customer.

### Advantage: Controlling the New (Automotive) Ethernet and IP Technologies

The new technologies may no longer be held back in motor vehicles. Protocols such as IP, AVB and TSN have thousands of pages of specifications and test suites. Being able to control these new protocols in automobiles is not trivial.

An aspect of the invention may be used in other communication systems with clock synchronization components and embedded systems.

### BRIEF DESCRIPTION OF THE DRAWINGS

An exemplary embodiment of the invention is depicted in the drawings and will be described in greater detail below. In the drawings:

FIG. 1 shows a general solution to the stated problem;

FIG. 2 shows a method for determining the relative position;

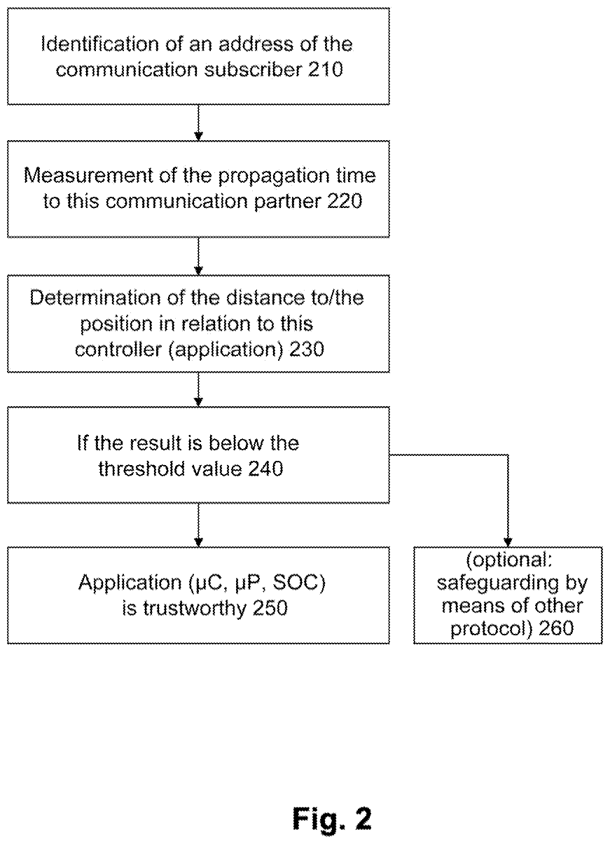

FIG. 3 shows a depiction of an application where a controller within the dedicated common ECU is a more secure method than one in the on-board electrical system;

FIG. 4 shows a trust verification if a controller is located directly on the same printed circuit board;

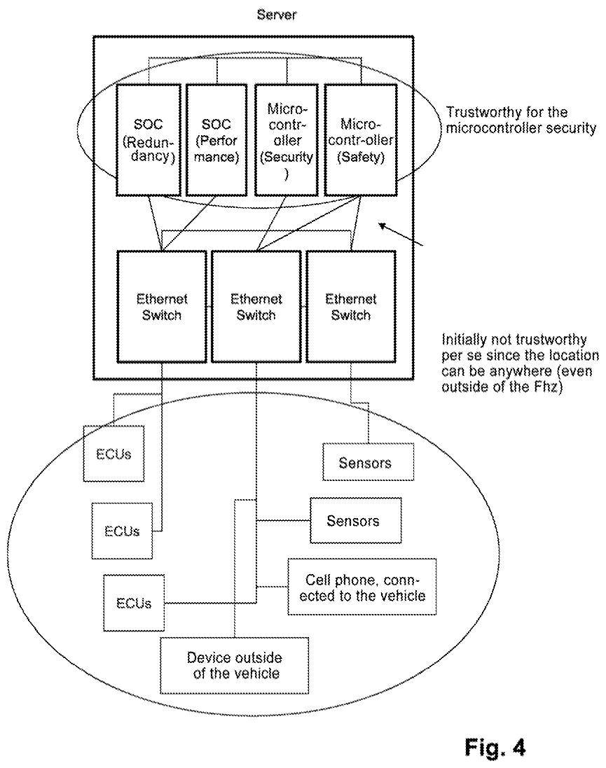

FIG. 5 shows a depiction of when the communication partner is trusted;

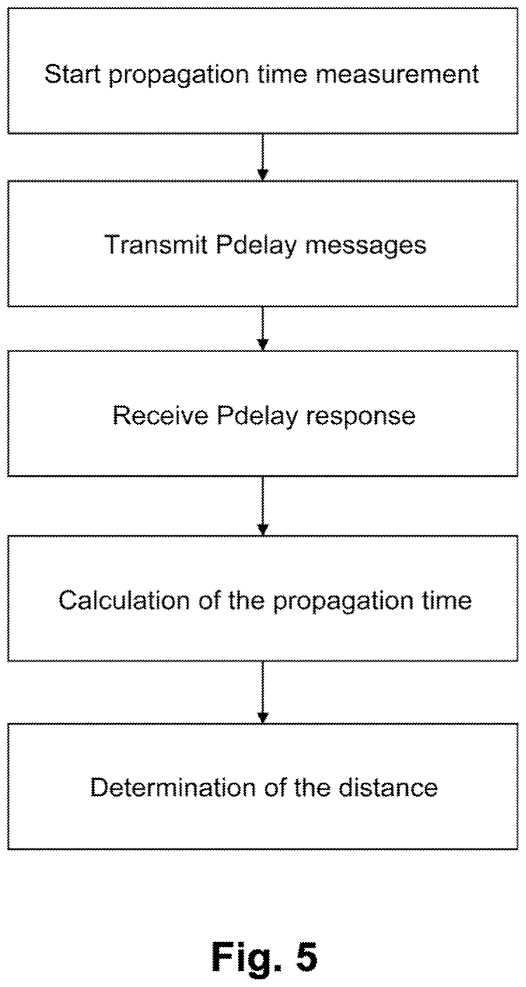

FIG. 6 shows the course of the method according to an aspect of the invention;

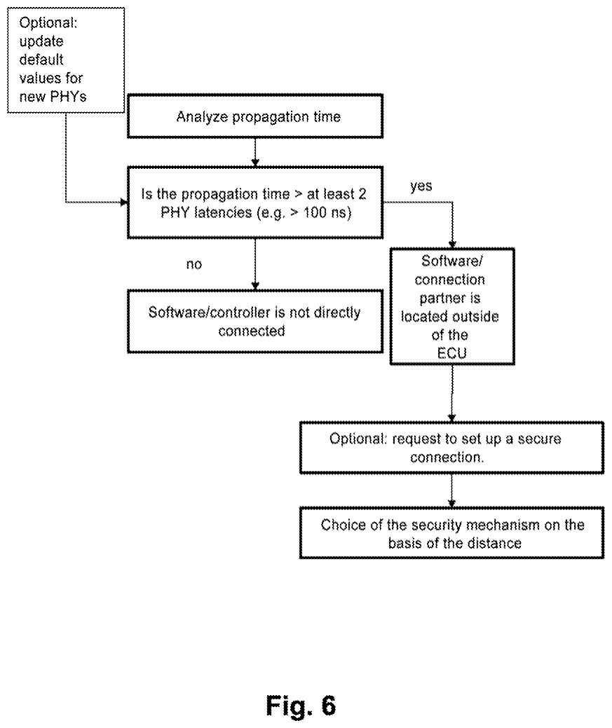

FIG. 7 shows position measurement by means of propagation time measurement and determination of the relative position;

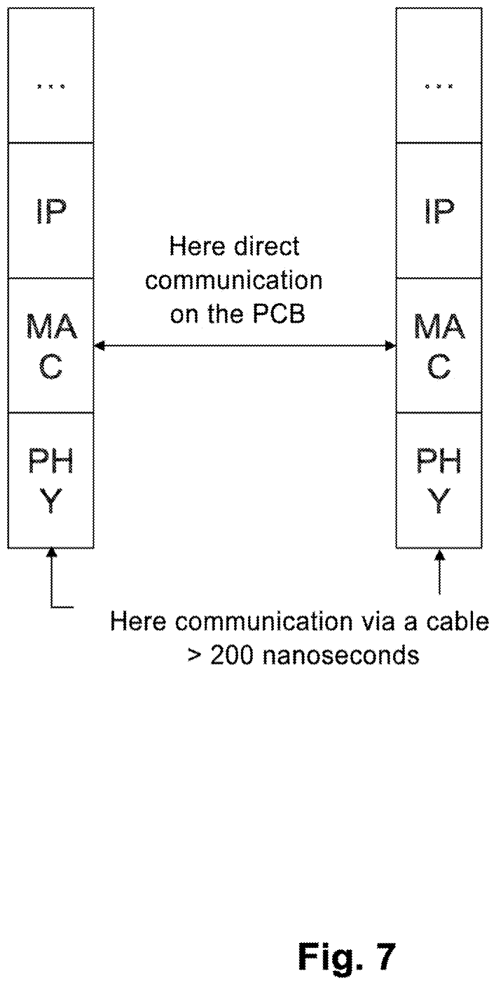

FIG. 8 shows a depiction of the PHY to PHY in contrast to MAC to MAC communication;

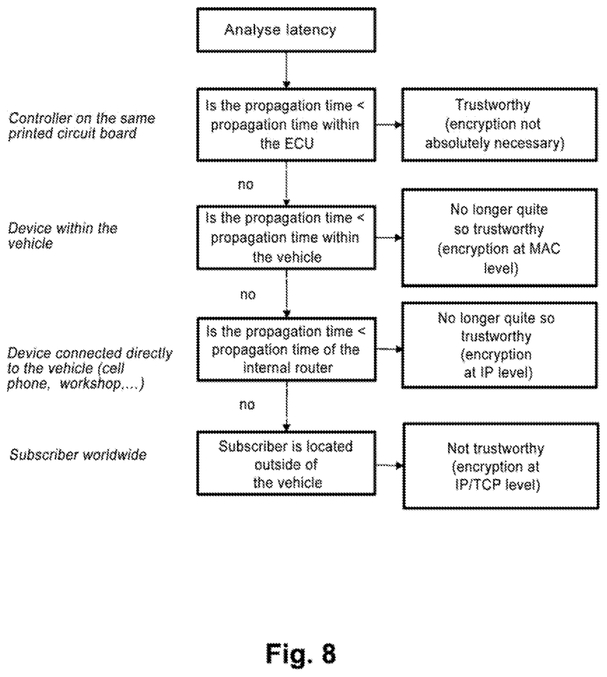

FIG. 9 shows determination of the position of another ECU/SW/address.

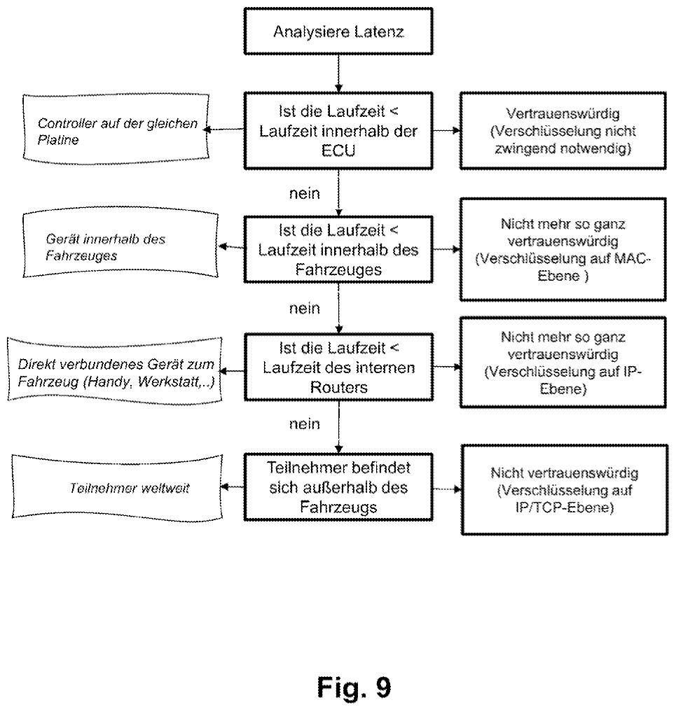

### DETAILED DESCRIPTION OF EXEMPLARY EMBODIMENTS

In the following, the notification of an aspect of the invention proposes a method in order to determine the trustworthiness of a communication partner (or its application). Provided that this trustworthiness is determined, the exchange of sensitive data can be carried out—for the other case, another solution is proposed (but is not the priority of the method).

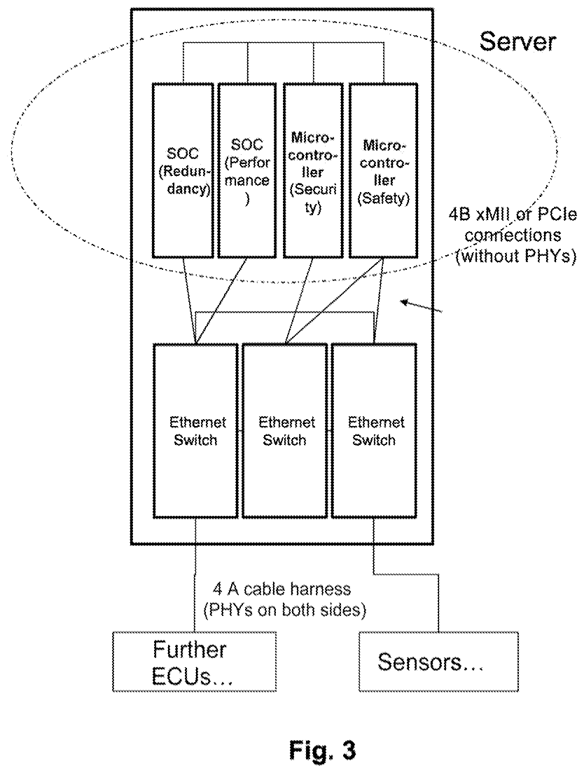

### FIG. 3

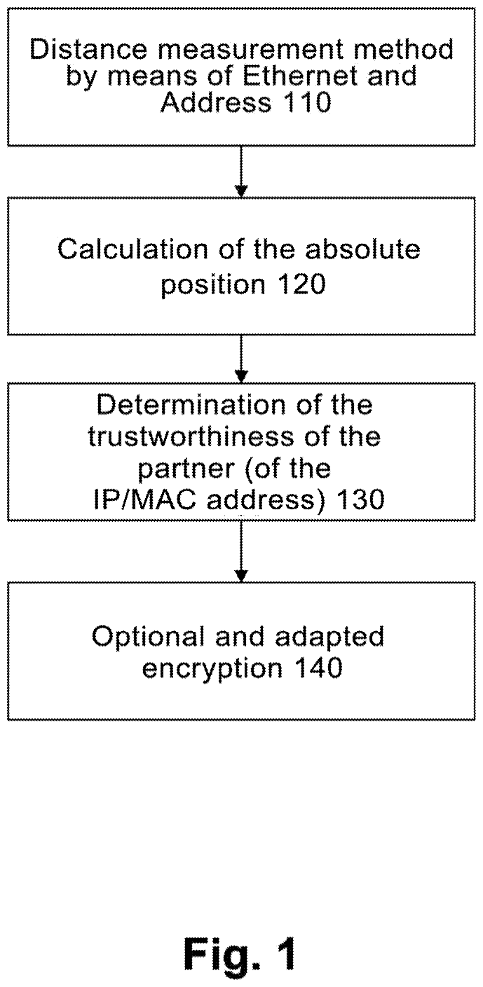

FIG. 1 shows a detail of an overall system architecture in which an ECU (server) is connected to further sensors and ECUs and components outside of the vehicle. The controllers on the server are typically connected on the PCB (printed circuit board) via MII (Media Independent Interface) or PCI Express and thus always manage without transceivers (PHYs).

An Ethernet transceiver (PHY) causes a delay in the 3-digit nanosecond range. This sounds small, but the delay on layer 2 (MAC) is approximately in the 1-digit nanosecond range or tends toward 0—depending on how high the resolution of the measurement is.

The method first of all determines the address of the application with which data are to be exchanged (received, sent or both).

The method then starts a propagation time measurement for this component. For example, the PDelay Request method of the gPTP protocol (or 802.1AS) may be used here. Two responses are sent back in response, and hardware timestamps can be used to determine the propagation time of the message. (The use of a protocol with hardware timestamps is important—NTP, for example, is thus ruled out because the resolution is too imprecise).

With the help of this calculated value, the method calculates the physical distance to this subscriber. The distance is not directly expressed here by a unit of measurement such as meters or centimeters, for example, but may be converted to the number of components (PHYs, switches) that are part of the connection, since this delay is significant in contrast to the delay on the actual cable.

The method measures the propagation time to a subscriber/address by starting propagation time measurements (for example part of the PTP protocol) and by calculating therefore the distance to this subscriber.

The measured propagation time must first be evaluated in order to provide an indication of the location. The software cannot know whether or not a partner is located within the same ECU, or ideally it must not know if generalized SW and not a special version is used; in addition, IP addresses may be falsified or changed.

The propagation time of an MII-based connection does not need PHYs (transceivers). However, neither the time synchronization software nor the actual application commissioning this investigation knows this. A PHY converts the data into electrical signals and encodes them, which takes much more time than when two Ethernet MACs communicate with one another over the MII-based lines.

The method presented recognizes whether a subscriber is directly connected to the requesting subscriber. If this is not the case, the appropriate protocol can be selected depending on the latency. For example, MACsec or IPsec could be used for latencies that apply within the vehicle, and other IP/TCP-based methods could be used if the latency is so high and the subscriber is undoubtedly located outside of the vehicle.

1. A method for encrypting security-relevant data in the vehicle, comprising:
an address of the respective communication subscriber in an Ethernet network is identified via the IP addresses,
the propagation time to this communication partner is measured, and
the distance to and/or the position in relation to this controller and/or application is determined,
wherein, if it is determined that the distance is below the threshold value, the application is classified as trustworthy.

2. The method as claimed in claim 1, wherein, for verification purposes, safeguarding is effected by another protocol.

3. The method as claimed in claim 1, wherein
following measurement of the propagation time to this communication partner and
following determination of the distance to and/or the position in relation to this controller and/or application,
a check is performed on the measurement of the propagation time in such a manner that
a) if a propagation time is shorter than the propagation time within the ECU, the communication subscriber is located on the same printed circuit board,
b) if a propagation time is shorter than the propagation time within the vehicle, the communication subscriber is located within the vehicle,
c) if a propagation time is shorter than the propagation time within the internal router, the communication subscriber is directly connected to the vehicle,
d) if a propagation time is longer than those in points a), b) and c), the communication subscriber is located outside of the vehicle.

4. The method as claimed in claim 1, wherein,
following analysis of the propagation time, a check is performed to determine whether the propagation time is longer than double the PHY latency,
wherein, if a propagation time is longer than double the PHY latency, the communication subscriber is located outside of the ECU, and
wherein, if a propagation time is shorter than double the PHY latency, the communication subscriber is not directly connected.

5. The method as claimed claim 1, wherein,
if the communication subscriber is located outside of the ECU, a request is made to set up a secure connection from one communication subscriber to the other communication subscriber, wherein the security mechanism for setting up a secure connection is effected depending on the distance ascertained.
